(19) United States
(12) Patent Application Publication
(10) Pub. No.: US 2001/0049633 A1
(43) Pub. Date: Dec. 6, 2001

(54) Transaction mediation system and a printing mediation system with use of the former system and a method for establishing transaction mediation network

(76) Inventors: Masato Yoshida, Kyoto-fu (JP); Ryuji Kawai, Kyoto-fu (JP)

Correspondence Address: Thomas J. D'Amico, DICKSTEIN SHAPIRO MORIN & OSHINSKY LLP, 2101 L Street NW, Washington, DC, 20037-1526, US

(21) Appl. No.: 09/777,886

(22) Filed: Feb. 7, 2001

(30) Foreign Application Priority Data
Feb. 8, 2000 (JP) 35629/2000

(51) Int. Cl. G06F 17/60

(52) U.S. Cl. 705/26

(57) ABSTRACT

A transaction mediation system and a printing mediation system is provided that enables products of high quality (printed matter) even in the case that the ordering quantity of the products (printed matter) is small. In case that the printed matter is ordered by the printing mediation center from the printing supplier and by the shop from the printing mediation center, the transaction is subjected to the first transaction price table and the second transaction price table respectively. In case that there exists at least plurality of shops that complies with the second transaction price table and that there is a relationship in which the price per unit quantity of the product in accordance with said first transaction price table is equal to or less than the price per unit quantity of the product in accordance with said second transaction price table, the printing mediation center mediates the order of the printed matter from the printing service of the shop.

### BACKGROUND OF THE INVENTION

1. Field of the Invention

The present invention relates to a transaction mediation system mediating the transaction with respect to the products between an orderer and a supplier and a printing mediation system applying the former system to the transaction of printed matter.

2. Background Art

In case of dealing in the production of printed matters through the Internet conventionally, a style used to be taken such that an electronic store on WWW (World Wide Web) receives an order from the terminal of a user and after printing by its own company or ordering from other printing company in stead of printing by its own company, a product of the printed matter is delivered to the user or a predetermined store etc.

However, in the related art such as mentioned above, there were problems such as follows.

That is to say, in case that an electronic store established on the Internet prints in its own company, since the order quantity from one user is limited, reduction in cost by economics of scale can not be expected while requiring manpower and also since the individual sales is small, low price setting was difficult. On the other hand, in case that an electronic store asks an order from other printing company for printing, since the order quantity of the individual electronic store to deal with is restricted, it was difficult for the printing company to undertake the order at a low price and even in case that the profits added to the stocking price from the printing company could be cut, it was difficult to lower the price at which the electronic store sells to users directly.

Additionally, in the field of light printing such as a postcard or a business card, originality is pursued in a design but under the condition that individual sales are small and the handling quantity is limited, preparing or accumulating the design having various kinds of variation to respond to the condition was difficult in the aspect of cost performance so that it was impossible to meet the users' needs sufficiently.

### SUMMARY OF THE INVENTION

The invention is proposed in order to solve the problems of the aforementioned related art and an object of the invention is to provide a transaction mediation system that enables holding down the price and providing products of high quality even though the user's order quantity of the product is small and to provide a printing mediation system which realizes the former system in the field of printing such as postcards or business cards.

To achieve the aforementioned object, in the invention, a transaction mediation system is proposed for mediating the transaction between an orderer and a supplier by establishing a transaction mediation network including the orderer, the supplier supplying a product in response to an order from the orderer and at least a mediator mediating the order. The transaction mediation system comprises first transaction price table storage means for storing a first transaction price table defining the relationship between the quantity of the product and its price such that the price per unit quantity of the product becomes cheaper in case that the mediator orders the quantity as a mass from the supplier, and second transaction price table storage means for storing a second transaction price table defining the relationship between the quantity of the product and its price such that the price per unit quantity of the product becomes cheaper in case that the orderer orders the quantity as a mass from the mediator, and transaction mediating network information storage means for storing information specifying the supplier and the orderer composing the transaction mediation network, in other words the supplier and the orderer having a relationship in which the price per unit quantity of the product based on said first transaction price table to which is subjected the supplier dealing in a specified product with the mediator is equal to or less than the price per unit quantity of the product based on the second transaction price table to which is subjected the orderer dealing in said specified product with the mediator.

Here, the product includes not only a tangible fortune but also an immaterial fortune such as for example services. In addition, the orderer is not limited to a person who receives an order from someone else like a user and orders it from an mediator, and the case may be included in which the orderer himself orders alone. The first transaction price table and the second transaction price table is not limited to those including all of the transaction quantity and the price of the products. They may include a part of the transaction quantity and the price and may also include a table by which a price that is not included therein is interpolated by means of computation expression from the numeric value of the table. In addition, the price table includes a computation expression for calculating the price based on the transaction quantity of a product or a computation program of such kind in stead of taking the style of a table.

In case that the mediation of the transaction of the product between the supplier and the orderer identified by the information stored in the transaction mediation network information storage means and the mediator composing the transaction mediation network with these persons, the transaction is subjected to the first transaction price table and the second transaction price table that satisfies the aforementioned relationship respectively. Then, if the orderer increases the order quantity, the transaction price per unit quantity in case that the mediator wholesales a product to the orderer becomes cheaper so that the profits made by the orderer increases. Since the order quantity from the mediator to the supplier increases by increasing the number of orders nevertheless the order quantity per each orderer does not vary, the transaction price per unit quantity in case that the supplier wholesales the product to the mediator becomes cheaper so that the profits made by the mediator increases. If the total order quantity from the mediator increases, the supplier as well can reduce the cost per unit quantity of the product by economics of scale so that the profits are increased. Therefore, even in the case that the profit margins which the mediator adds to the transaction price is not set large in case of a wholesale of the product from the supplier to the mediator, profits are generated. In addition, even if the profit margins which the orderer adds to the retail price is not set large similarly in case that the orderer further sells off the product to the user, profits are generated. In other words, the product is provided to users at a lower price.

In addition, the first transaction price table storage means, the second transaction price table storage means and the transaction mediation network information storage means are not limited to the means that store the information electromagnetically or optically such as HD, CD (Compact Disk), FD (Flexible Disc) or MO (Magneto-Optical disk) and they may be the means stored visibly in a medium like a paper such as the document of Franchisees contract concluded between the orderer and the mediator or the document of the product feed contract concluded between the supplier and the mediator.

In addition, the system may comprise first transaction price table register means for storing by the person hoping for transaction as the supplier the first transaction price table describing the transaction price in the first transaction price table storage means, and second transaction price table calculating means for calculating the second transaction price table based on the stored first transaction price table wherein the price per unit quantity of the product based on the first transaction price table is equal to or less than the price per unit quantity of the product based on the calculated second transaction price table, and second transaction price table providing means for providing the second transaction price table to a person hoping for a transaction as an orderer.

In this way, even as for the product whose supply quantity is unstable and whose price of the wholesale from the supplier to the mediator is easy to fluctuate, the transaction mediation network including the orderer can quickly be established and it is made possible to provide at an appropriate price such product that is easy to fluctuate in price. Similarly, a person who hopes for a transaction as a orderer may register the second transaction price table in the second transaction price table storage means by the second transaction price table storage means and calculate the first transaction price table based on the second transaction price table by the first transaction price table calculating means and provide the first transaction price table to a person who hopes for a transaction as a supplier by the first transaction price table providing means.

In addition, preferably the above-mentioned orderer is a mediator who mediates the order of a user and has order reception means to accept orders from a user and a transmission path to transmit the order reception means to the terminal of the user is arranged.

By the way, the order reception means may be the one fixed like reception apparatus installed in a store but if the transmission path extending to the terminal of a user is established, more positive order acquisition becomes possible. Here, the user's terminal consists of PC etc. and in addition to the case in which the Web page including the inputting form as reception means transmitted to the user's terminal from the shop on the Web as an orderer using the communication channel such as the Internet as a transmission path, a case may also be included in which the user's terminal is a place where the user stays and the orderer is a person engaged in business activities who visits the place where the user stays by way of a transmission path like road carrying the order reception means such as a portable PC.

In addition, the invention relates to a printing mediation system in which printed matter is a object product for transaction according to either one of the aforementioned transaction mediation system, wherein the order has image for processing information storage means for storing the image information used for processing and process condition storage means for storing the information about process condition specifying the processing steps that should be implemented against the image information during the forming process of the printed matter, and the mediator has printing image producing means for producing printing image information by processing the steps specified for the image for printing information and the supplier has printing means for producing printed matter based on the image for printing information, and the system comprises processing information transmission means for transmitting the image for processing information stored in the image for processing information storage means and the information about the process condition stored in the process condition storage means to an image for printing information producing means and, an image for printing information transmission means for transmitting the image for printing information from the image for printing information producing means to the printing means.

As thus described, applying the transaction mediation system to the production of printed matter, printed matters such as business cards or postcards whose order quantity per one order is small can be provided at a low price.

In addition, using a network such as the Internet or exclusive line as information transmission means or printing image information transmission means, a lot of information can be transmitted precisely and quickly so that it is made possible to produce the printed matter of high quality with short delivery.

In addition, preferably the mediator may have a design information database including at least either one of the image information used for producing the image for printing and the information about processing steps, and the image for printing producing means may call either one of the image information corresponding to the information about the process condition and the information about processing steps from the design information database and produces the image for printing.

In this way, as for the printed matter of small order quantity per one order, a printed matter having a design rich in originality and corresponding to various kinds of user's taste can be provided at a low price.

In addition, preferably the orderer has image information for identification producing means for producing the image information for identification indicating the condition of printed matter in case that the processing steps are processed according to the condition specified for the image for processing information, and design information for identification storage means for storing at least a part of at least either one of image information and information about processing steps stored in the design information database. The image for identification information producing means calls at least either one of the image information corresponding to the information about process condition stored in the process condition storage means and the information about process steps from the design for identification information storage means and produces the image for identification. The orderer has design information transmitting means for transmitting at least a part of the image information or the information about processing steps stored in the design information database to the design information for identification storage means.

In this way, the inconsistency between the user and the orderer upon the order disappears and such troubles can be eliminated that the produced print differs from the contents of the order or the expected print and the user can order worry-free and designates the process condition precisely. In addition, as for the orderer as well, since new design information is provided from the design information database, it is made possible to suggest a wide variety of new products consistently.

Additionally, the invention relates to a method for establishing transaction mediating network including a orderer and a supplier supplying products in accordance with the order from the orderer and a mediator mediating the transaction of product supply. The method comprises the steps of joining the mediator and the supplier together by means of transaction relationship in accordance with a first transaction price table in which the price per unit quantity of the product becomes cheaper in case that the mediator orders for a quantity as a mass from the supplier, and joining the mediator and at least plurality of orderers together by means of transaction relationship in accordance with a second transaction price table in which the price per unit quantity of the product becomes cheaper in case that the orderer orders for a quantity as a mass from the mediator, and joining the orderer and the supplier together by the assistance of the mediator, wherein the orderer and the supplier is joined together with the mediator for a specified product and has a transaction relationship in accordance with the first transaction price table and the second transaction price table in which the price per unit quantity of the product in accordance with the first transaction price table is equal to or less than the price per unit quantity of the product in accordance with the second transaction price table.

In this way, with the establishment of the transaction mediating network, as the orderer who participates in the transaction increases the order quantity per orderer and the mediator increases the total number of the orderers or the total number of the order quantity, the profits can be increased without increasing the profit margin added to the wholesale price so that it is made possible to provide the user with products at a lower price.

### BRIEF DESCRIPTION OF THE DRAWINGS

FIG. 1 is a block diagram showing the schematic architecture of the printing mediation system; and

FIG. 2 is a block diagram showing the detailed architecture of the printing mediation system.

### DETAILED DESCRIPTION OF THE PREFERRED EMBODIMENTS

With reference to the drawings, a preferred embodiment of the invention is described hereinafter.

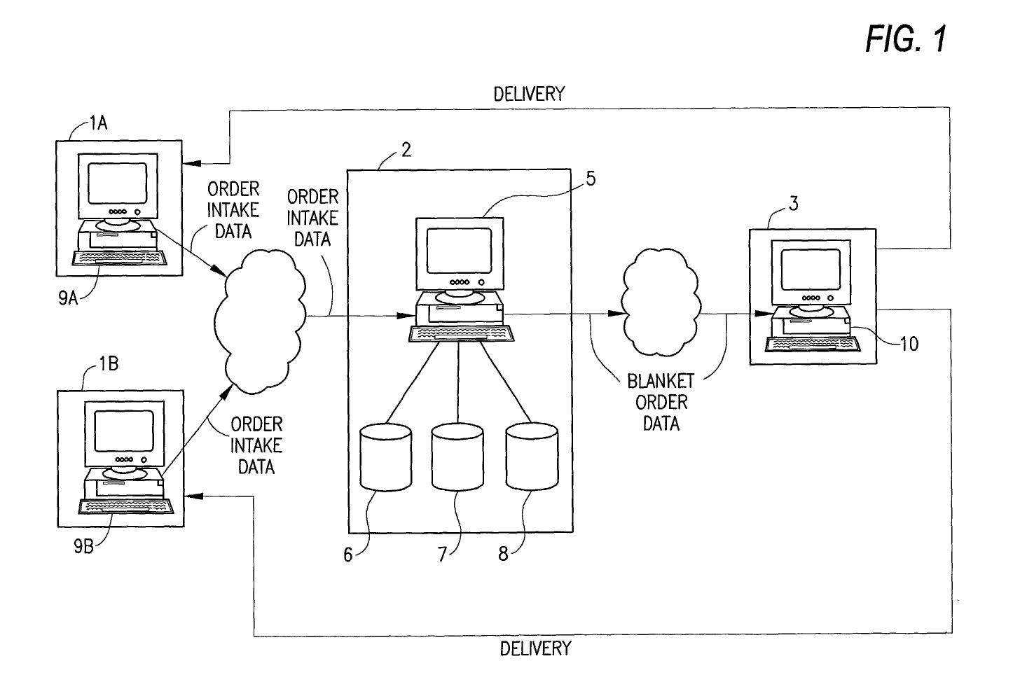

FIG. 1 is a block diagram showing the schematic architecture of the transaction mediation system according to the preferred embodiment of the invention.

The printing mediation system as one example of the transaction mediation system is described. In the printing mediation system, shop 1a, 1b as an orderer receives the order of printed matter such as postcards or business cards from a user and orders from printing mediation center 2 as an mediator. The printing mediation center 2 produces image information necessary for printing in accordance with the order from the shop 1a, 1b orders printing collectively to a printing service 3 as a supplier, the printing service 3 produces a printed matter, and the produced printed matter is delivered to users or the shop 1a, 1b.

The printing mediation control server 5 installed in the printing mediation center 2 is connected to the first transaction price table storage apparatus (the first transaction price table storage means) 6 such as HD in which is stored a table prescribing the relationship between the order quantity of the printed matter and the transaction price in case that the printing supplier 3 contracts printing on the order from the printing mediation center 2 and the second transaction price table storage apparatus (the second transaction price table storage means) 7 such as HD in which is stored a table prescribing the relationship between the order quantity of the printed matter and the transaction price in case that the shop asks order from the mediator. In addition, the printing mediation control server 5 is connected to the printing mediation network information storage apparatus (transaction mediation network information storage means) 8 such as HD, specifying the shop 1 comprising the printing mediation network through the printing mediation center 2 and the printing supplier 3.

The printing mediation control server 5 is connected to the terminal 9a, 9b of the shop 1a, 1b hoping for orders by means of a network (NW) such as the Internet and accepts an application of transaction in accordance with such price table in which transaction price per unit quantity becomes cheaper in case that the order quantity of the printed matter from the shop 1 is gathered up. On the other hand, printing mediation control server 5 is connected to the terminal 10 of the printing supplier 3 by means of a network (NW) such as the Internet and accepts an application of transaction in accordance with the price table in which transaction price per unit quantity becomes cheaper in case that order quantity of the printed matter from the mediator is gathered up. The accepted first transaction price table and the second transaction price table is stored respectively in the first transaction price table storage apparatus 6 and the second transaction price table storage apparatus 7.

The printing mediation control server 5 calls the first transaction price table with which the printing supplier asking the order complies and the second transaction price table with which the shop hoping for the order complies and compares the transaction price per unit quantity in each order quantity. In case that the transaction price of the printed matter per unit based on the first transaction price table is equal to or less than the transaction price of the printed matter per unit based on the second transaction price table and that at least plurality of shops hoping for the order in accordance with the above-mentioned second transaction price table exist, a printing mediation network via printing mediation center 5 is established by the above-mentioned shop hoping for the order and the printing suppliers hoping for the transaction and then the information specifying the shop and the printing supplier is registered to be stored in the printing mediation network information storage apparatus 8.

Table 1 is the first transaction price table with which the shop 1a, 1b complies showing in the case of business card the relationship between the number of boxes for order and the wholesale price and the wholesale price per one box upon the wholesales from printing mediation center 2 to the shop 1a. It is constructed such that the greater the number of orders (number of the boxes), the cheaper the transaction price per unit (wholesale unit price) becomes.

TABLE 1

| Number of Boxes (100 | Wholesale Unit Price | Wholesale Price |
|---|---|---|
| pieces/box) | (Yen) | (Yen) |
| 1 | 1,300 | 1,300 |
| 2 | 1,300 | 2,600 |
| 3 | 1,300 | 3,900 |
| . . . | . . . | . . . |
| 7 | 1,300 | 9,100 |
| 8 | 1,200 | 9,600 |
| 9 | 1,100 | 9,900 |
| 10 | 1,000 | 10,000 |
| . . . | . . . | . . . |
| 12 | 1,000 | 12,000 |
| . . . | . . . | . . . |

Table 2 is the second transaction price table with which the printing supplier 3 complies showing similarly in the case of business card the relationship between the number of boxes for order and the wholesale price and the wholesale price per one box upon the wholesales from the printing suppliers 3 to the printing mediation center 2. It is constructed such that the greater the number of orders (number of the boxes), the cheaper the transaction price per unit (wholesale unit price) becomes.

TABLE 2

| Number of Boxes (100 | Wholesale Unit Price | |
|---|---|---|
| pieces/box) | (Yen) | Wholesale Price (Yen) |
| 1 | 1,300 | 1,300 |
| 2 | 1,300 | 2,600 |
| 3 | 1,300 | 3,900 |
| . . . | . . . | . . . |
| 7 | 1,300 | 9,100 |
| 8 | 1,200 | 9,600 |
| 9 | 1,100 | 9,900 |
| 10 | 1,000 | 10,000 |
| . . . | . . . | . . . |
| 12 | 1,000 | 12,000 |
| . . . | . . . | . . . |

In this case, comparing the first transaction price table shown in Table 1 with the second transaction price table shown in Table 2, the transaction price per unit quantity of printed matter based on the first transaction price table shown in Table 1 is equal to the transaction price per unit quantity of the printed matter based on the second transaction price table shown in Table 2 and there are plurality of shops 1a, 1b that asks orders in accordance with the second transaction price table. Therefore, printing mediation network including the shop 1a, 1b and printing supplier 3 is established and the information specifying the shop 1a, 1b and printing service 3 is stored in the printing mediation network information storage apparatus 8. Suppose the retail prices from shop 1a, 1b is uniformly set 3,000 yen per one box here and the shop 1a accepts an order of one box respectively from three users and the shop 1b accepts an order of one box respectively from nine users. The amount of earnings of the shop 1a is 3,000×3=9,000 yen and the amount of money for laying up stock is 3,900 yen according to Table 1 and the sales profits is 5,100 yen. The amount of earnings of the shop 1b is 3,000×9=27,000 yen and the amount of money for laying up stock is 9,900 yen according to Table 1 and the sales profits is 17,100 yen. As the printing mediation center asks an order for 12 boxes from the printing supplier, the amount of earnings of the printing mediation center is 3,900+9,900=13,800 yen and the amount of money for laying up stock becomes 12,000 yen according to Table 2 and the sales profits is 1,800 yen. And the amount of earnings of a printing supplier is 12,000 yen.

The printing mediation network is established in this way, the transactions between the shop 1a, 1b and the printing mediation center are processed in accordance with the second transaction price table shown in Table 2 and the printing of printed matter ordered by these shops is consigned to the printing supplier 3 and so the transaction between the printing mediation center and the printing supplier 3 is processed in accordance with the first transaction price table shown in Table 1.

Even though each of the price table is set such that the transaction price per unit quantity of a product becomes the same between the shop 1a, 1b and the printing mediation center 2 and between the printing mediation center 2 and the printing supplier 3 as described above, by bundling up at least plurality of shops, profits are produced in whichever of the shop 1a, 1b, the printing mediation center 2 and the printing service 3. In other words, since profits can be produced without adding big profits to the stocking price at the stage of shop 1a, 1b and printing mediation center 2, printed matter can be offered at a low price to users.

According to the above-mentioned system, in the printing mediation control server 5, the first transaction table to which the transaction between the printing mediation center 2 and the printing service 3 should be subjected is compared with the second transaction table to which the transaction between the shop 1 and the printing mediation center 2 should be subjected and in case that the transaction price of the printed matter per unit quantity based on the first transaction table is equal to or less than the transaction price of the printed matter per unit quantity based on the second transaction table and that a plurality of shops dealing in accordance with the second transaction price table exist, printing mediation network is established. However, in case that a printing contract between the printing supplier 3 and the printing mediation center 2 dealing continually in accordance with the first transaction price table and a Franchisees contract between the printing mediation center 2 and the shop 1a, 1b dealing continually in accordance with the second transaction price table and that the printing mediation center 2 is concluded and that there exists two or more shops having coupled a Franchisees contract and that the first transaction price table and the second transaction price table satisfy the above-mentioned relationship, the printing mediation network is established on the couplings of the printing contract and the Franchisees contract. In such case, in case that the printing mediation control server 2 identifies during printing mediation based on the ID information that both of the shop 1a and the printing service 3 participating in the transaction belongs to a predetermined printing mediation network stored in the printing mediation network information storage apparatus 8, assuming that the network including the shop concerned and the printing service being established, the following process is performed in accordance with the condition such as the price table prescribing the network concerned.

With regard to the reception of the application of the transaction, for the printing supplier may be provided the first transaction price table stored in the first transaction price table storage apparatus and for the shop hoping for the order may be provided the second transaction price table stored in the second transaction price table storage apparatus and so the transaction price table to be complied with may be specified by admitting the presented transaction price table or by choosing either one of the presented plurality of transaction price tables.

In addition, providing the first transaction price table with which the printing supplier should comply on receiving the contract of printing and preparing the second transaction price table by calculating at the printing mediation control server (the first transaction price table register means, the second transaction price table calculating means) the transaction price at which the transaction price of the printed matter per unit quantity based on the first transaction table is equal to or less than the transaction price of the printed matter per unit quantity based on the second transaction table, printing mediation network may be established by receiving in accordance with the second transaction price table the application from the shop hoping for the order of the printed matter. In addition, the printing mediation network can be established to include the printing supplier that presented and provided the cheapest price table by comparing mutually the first transaction price tables provided by plurality of printing suppliers.

(Flow of the Steps in the Printing Mediation System)

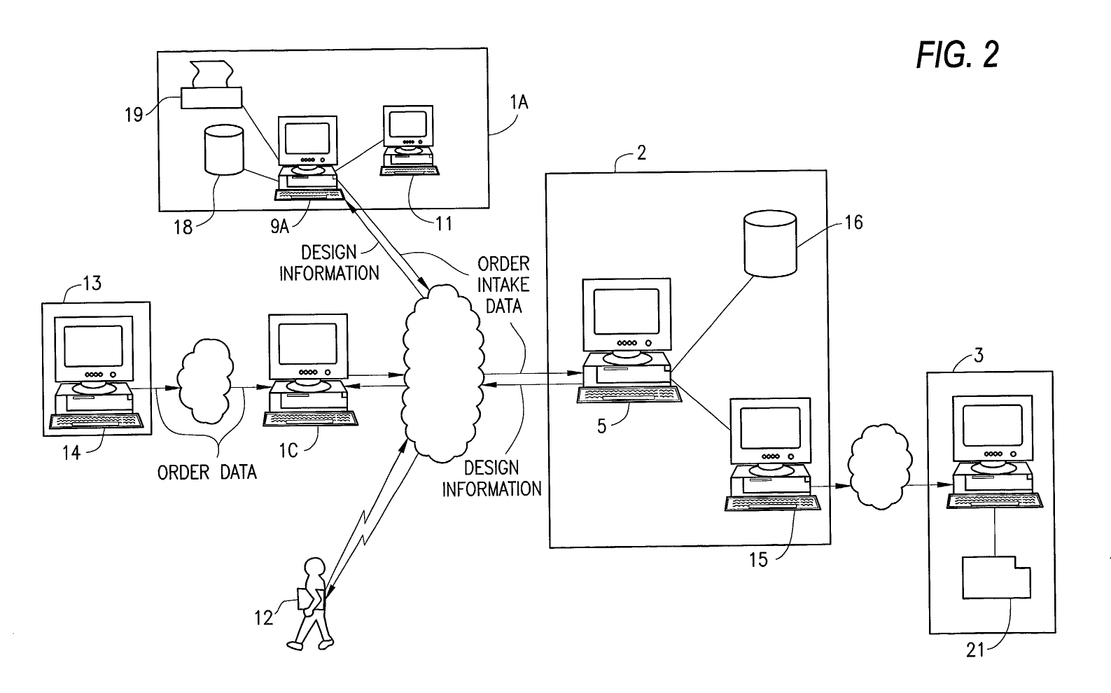

Referring now to FIG. 2, the flow of the steps in the printing mediation system is explained in detail as follows.

A shop may be an existing store actually, otherwise it may be an electronic store on a Web. In addition, the shop is not limited to the one that occupies a certain space at a specified place and it includes those realized as a person engaged in sales activities and having no locational restrictions. If in the case that the shop exists physically, an actual object such as the printing samples can be presented so that the doneness of the printing matter can be realized and it also can give a trust to the user unlike the electronic store on a Web.

In a shop, an order is received from a user by the following steps. At first, users are asked to fill out the necessary matter in the order form. In the order form is included properties such as full name of the user, the address and the telephone number or indication about the process condition. If in the case there is image information used for production of the printed matter such as photography, logotype, mark and the samples for layout, they are received by the shop side.

Now, a user visits shop 10a where the exclusive reception apparatus 11 is installed and the person in charge of the shop inputs defined description of the order form and captures the image information by means of a digital camera or a scanner depending on the record form and these information are stored in a predetermined medium. Alternatively, the person in charge carrying a portable reception apparatus 12 may visit the user for the similar activities. In case that the shop 10b is an electronic store on the Web, ordering information etc. may be stored by displaying the Home Page transmitted from WWW server by WWW browser on the terminal 13 of the user and inputting the requirements according to the entry form. The stored information is transmitted to the printing mediation center by the transmission means that meets each form of the information. It is transmitted to the printing mediation center by transmission means such as an electronic mail with attached file or a delivery.

Image for printing image producing server 15 is connected to the printing mediation control server 5 and the image for printing is generated by processing the image for processing information in accordance with the designated process condition in the transmitted order form. Then, the printing mediation control server, to which is connected the design information database 16 that accumulated the image information for producing the printing image such as for example template and the information about processing steps, calls necessary information according to the process condition. An architecture may be available in which not only the established image information or the processing step information but also the image information and the processing step information that a designer creates afresh depending on the order of a user are included virtually in the design information database 16. In this case, the property of the registered designer is stored and when a user specifies a designer and orders printed matter being a creation of an original design, the design is ordered to the designer designated based on the property of the designer, and the image information and the processing step information necessary for the realization of the created design are stored in the design information database 16 and the printing image is generated based on these information. Arranging such design information database 16, a design with originality or a design to meet various tastes of an individual user is made possible.

Part of the image information and the processing step information used for producing the image for printing is transmitted to the terminal 17 of the shop 10a and stored in the design information for identification storage apparatus (design for identification information storage means) such as HD. In the terminal of the shop 10a, image information for ensuring the workmanship of the printed matter is produced based on the stored information in accordance with the order from the user and displayed by image output for identification means such as printer 19 (or display) or printed out to a medium such as paper. Since the image for identification need not be outputted with an accuracy of the resolution nearly equal to that of the printed matter, by means of an abbreviation or the like of a part from the information used for producing the image for printing, the information corresponding to the information of a lower level of accuracy may preferably be stored in the terminal 17.

The image for printing information produced by the print image producing server 15 is transmitted through the network such as the Internet to the print control terminal 20 managed by the printing supplier 3. The print control terminal 20 is an apparatus that manages and controls the printing apparatus 21 such as on-demand printing machine. The print control terminal 20 controls printing apparatus 21 based on the print image information and processes the printing step. With the usage of on-demand printing machine, even a small quantity of the printed matter can be printed quickly and neatly and also the printing that meets various needs of a user becomes possible. In addition, it is made possible to easily respond to the printed matter whose contents are changed frequently like a menu or a price table of a restaurant. Furthermore, the documents for conference or for sales promotion printed conventionally in monochromatic can be printed with color so that the added value can be raised.

In the printing supplier 3, gravure printing machine, offset duplicator or screen printing machine may be used aside from the on-demand printing machine.

The completed printed matter is delivered to the destination of the delivery specified by the user in the order form.

The establishment of printing mediation network that incorporates a person such as for example the business person in charge as a shop as well as a stationary store makes it possible to start a shop with a light burden of initial investment and at a low risk. In addition, if the business person in charge of sales such as engaged in a car dealer or a life insurance in charge of corporation becomes a shop anew, the shop can be utilized as a tool for promoting the business activity oriented to incorporated companies.

In the present embodiment, a printing mediation system is described in which the printed matter is a handled product but the printing mediation system according to the present invention can be applied for other products equally. In addition, it can be applied to a transaction mediation system where not only a piece but also various kinds of products are dealt in.

As described above, according to the present invention, even a product with a small ordering quantity from a user can be provided at a lower price. In addition, according to the present invention, printed matter such as a postcard or a business card as well can be provided at a low price.

What is claimed is:

1. A transaction mediation system for mediating the transaction between an orderer and a supplier by establishing a transaction mediation network including the orderer, the supplier supplying a product in response to an order from said orderer and at least a mediator mediating said transaction, said system comprising:
first transaction price table storage means for storing a first transaction price table defining the relationship between the quantity of the product and its price such that the price per unit quantity of the product becomes cheaper in case that the mediator orders a quantity as a mass from the supplier;
second transaction price table storage means for storing a second transaction price table defining the relationship between the quantity of product and its price such that the price per unit quantity of the product becomes cheaper in case that the orderer orders a quantity as a mass from the mediator; and
transaction mediating network information storage means for storing information specifying the supplier and the orderer composing the transaction mediation network, in other words the supplier and the orderer having a relationship in which the price per unit quantity of the product based on said first transaction price table to which is subjected the supplier dealing in a specified product with the mediator is equal to or less than the price per unit quantity of the product based on said second transaction price table to which is subjected the orderer dealing in said specified product with the mediator.

2. Transaction mediation system of claim 1 comprising:
first transaction price table register means for storing the first transaction price table describing transaction price in said first transaction price table by the person hoping for a transaction as said supplier;
second transaction price table calculating means for calculating the second transaction price table based on said stored first transaction price table wherein the price per unit quantity of the product based on said first transaction price table is equal to or less than the price per unit quantity of the product based on the calculated second transaction price table; and
second transaction price table providing means for providing the second transaction price table for a person hoping for a transaction as an orderer.

3. Transaction mediation system of claim 1 to 2, wherein said orderer is a mediator mediating the order of the user and has order reception means for receiving the order of the user, and said system comprises a transmission path for transmitting said order reception means to said terminal of the user.

4. Printing mediation system according to the transaction mediation system of claim 1 to 3 in which the object product for transaction is a printed matter, wherein:
said orderer has image for processing information storage means for storing the image information used for the process and process condition storage means for storing the information about the process condition specifying the processing steps that should be implemented against said image information during the producing process of the printed matter;
said mediator has image for printing producing means for producing image for printing information by processing the specified steps against the image for processing information;
said supplier has a printing means for producing the printed matter based on said image for printing information; and
said printing mediation system further comprising:
process information transmission means for transmitting the image for printing information stored in said image for processing information storage means and the information about the process condition stored in said process condition storage means to said image for printing producing means; and
image information for printing transmission means for transmitting said image for printing information from said image information for printing producing means to said printing means.

5. Printing mediation system of claim 4, wherein:
said mediator has a design information database including at least either one of the image information used for producing the image for printing and the information about processing steps; and
said image for printing producing means calls either one of the image information corresponding to the information about said process condition and the information about the process steps from said design information database and produces the image for printing.

6. Printing mediation system of claim 5, wherein:
said orderer has image information for identification producing means for producing the image information for identification indicating the condition of the printed matter in case that the processing steps are implemented according to the process condition specified for said image for processing information, and design for identification information storage means for storing at least a part of at least either one of the image information and the information about the processing steps stored in said design information database, whereby said image information for identification producing means calls at least either one of the image information corresponding to the information about the process condition stored in the process condition storage means and the information about processing steps from said design information for identification storage means and produces the image for identification, said image information for identification producing means calling at least either one of the image information corresponding to the information about the processing condition stored in said processing condition storage means and the information about the process steps from said design for identification information storage means to produce image for identification; and
said transaction mediation system further comprises design information transmitting means for transmitting at least a part of the image information or the information about producing steps stored in said design information database to said design information for identification storage means.

7. A method for establishing transaction mediating network including a orderer and a supplier supplying products in accordance with the order by said orderer and a mediator mediating said transaction of product supply, said method comprising the steps of:
joining the mediator and the supplier together by means of transaction relationship in accordance with a first transaction price table in which the price per unit quantity of the product becomes cheaper in case that the mediator orders for a quantity as a mass from the supplier;
joining the mediator and at least plurality of orderers together by means of transaction relationship in accordance with a second transaction price table in which the price per unit quantity of the product becomes cheaper in case that the orderer orders for a quantity as a mass from the mediator; and
joining the orderer and the supplier together by the assistance of the mediator, wherein said orderer and the supplier is joined together with the mediator for a specified product and has a transaction relationship in accordance with the first transaction price table and the second transaction price table in which the price per unit quantity of the product in accordance with said first transaction price table is equal to or less than the price per unit quantity of the product in accordance with said second transaction price table.
